(19) United States
(12) Patent Application Publication
(10) Pub. No.: US 2013/0248557 A1
(43) Pub. Date: Sep. 26, 2013

(54) Dry Powdered Comestibles and Serving Methods Therefor

(71) Applicant: Cole Alexander Egger, Dallas, TX (US)

(72) Inventor: Cole Alexander Egger, Dallas, TX (US)

(21) Appl. No.: 13/564,887

(22) Filed: Aug. 2, 2012

Related U.S. Application Data
(60) Provisional application No. 61/613,586, filed on Mar. 21, 2012.

(51) Int. Cl. B65B 1/04; A23L 1/29

(52) U.S. Cl. CPC B65B 1/04; A23L 1/296
USPC 222/1; 426/658; 53/473

(57) ABSTRACT

Powdered compositions and methods of use applicable to mitigate a condition of human fatigue among others, including a base composition of at least one finely powdered sugar, a flavoring, a binder and packaging for the compositions including a time incremented gauging means for a consumer to determine the amount of composition ingested according to an estimated duration of biological activity for a given amount ingested. The dry compositions are made available in a variety of flavors and are poured directly into the mouth without pre-mixing with liquids.

### CROSS REFERENCE TO RELATED APPLICATIONS

This application claims the benefit of prior filed U.S. application Ser. No. 13/354,252 filed Feb. 22, 2012 and U.S. Provisional Patent Application No. 61/613,586 filed Mar. 30, 2012.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

This invention relates generally to a dry powdered comestibles introduced directly into the mouth without prior mixing with liquids and methods therefor, and more specifically, a packaging method providing time-graduated measuring means for serving powdered comestibles.

### BACKGROUND OF THE INVENTION

Various powdered comestibles, such as powdered candies are long known in the art. One such candy Pixy Stix®, has been produced since the 1950's. Fun Dip™, is a similar powdered candy sold in pouches. In the 19^{th} century “fizzy” powders were originated that produced an effervescent flavored beverage when placed in water. Such fizzy powders typically contained sugar, baking soda and citric acid. One of the sensations of the orally consumed powders is to produce a dry sour puckering sensation resulting from the citric acid.

Powdered delivery offers a novel way to ingest nutraceuticals which can include compositions to alleviate hypoglycemia, and vitamin and energy boosting compositions among others.

Regarding energy boosting compositions, various combinations of vitamins, minerals, sugars have been developed over the years, some of which include caffeine. Most of these are provided in a liquid state, or a dry-powdered state for mixing with a liquid. However, over consumption of the product can be an issue. This can be especially problematic when the composition contains caffeine.

Regarding hypoglycemia, abnormally low glucose can produce a variety of symptoms and effects but the principal problems arise from an inadequate supply of glucose to the brain, resulting in impairment of function (neuroglycopenia). Effects can range from mild dysphoria to more serious issues such as seizures, unconsciousness, and in rare circumstances, permanent brain damage or death. In older children and adults, moderately severe hypoglycemia can resemble mania, mental illness, drug intoxication, or drunkenness. In the elderly, hypoglycemia can produce focal stroke-like effects or malaise. Frequently, the symptoms of a single person are similar from episode to episode, but may be influenced by the speed at which glucose levels are dropping. Treatment of mild hypoglycemia involves restoring the blood glucose level to normal by the ingestion or administration of dextrose or carbohydrate foods. As in the case of energy boosting compositions, over consumption of simple sugars taken to alleviate a condition of hypoglycemia can cause problems such as glucose levels initially spiking and then crashing.

Because the physical symptoms of the hypoglycemic state is frequently individualized, it is possible for hypoglycemic subjects to comprehend their own early-onset manifestations of the hypoglycemic state in order to circumvent more serious symptoms. Means traditionally used to correct for the hypoglycemic state by quickly raising blood glucose levels are glucose pills which are typically chewable, or edible glucose gel which may be absorbed quickly. Complaints regarding the texture of glucose pills and the messiness of glucose gel products remain an inhibitor of consumer acceptance, especially among children who unlike their parents, may not appreciate the serious consequences of failure to maintain normal glucose levels.

It would be desirable to produce a dry powdered comestibles that are of a composition that can dissolve rapidly within the oral cavity and promotes sufficient enzyme production, so that the composition is absorbed quickly into the bloodstream. More particularly, several bodily conditions such as hypoglycemia, fatigue or malnutrition can be treated with an orally consumed dry powder which does not linger in the mouth, but dissolves, and is absorbed by the body for quick effect. Furthermore, it would desirable to provide such a product in a form that readily absorbs, is easily swallowed, is dose packaged, and travels well in a pocket, a lunchbox or a purse.

It would further be desirable to provide a means of gauging the amount of comestible consumed, whether by single dose packaging where the entire contents are placed into the mouth or multiple dose packaging with time-graduated means.

### SUMMARY OF THE INVENTION

Disclosed are embodiments according to the present invention that when taken into the mouth directly, and which under normal intraoral conditions require no added drink to dissolve and be absorbed by the body. Methods according to the present invention are practiced with dry powdered comestibles with and without vitamins for boosting energy levels. More particularly, the invention describes methods incorporating a dry finely powdered comestible contained in an easily opened and content graduated packaging. The powdered comestibles, depending on the particular composition, when introduced directly into the mouth by way of the packaging, are capable of inter alia, boosting energy levels, supplementing nutrition and maintaining normal glucose levels. Typically, the comestible is a dry powdered mixture having a base of at least one water soluble simple sugar and at least one polysaccharide to which various purpose-specific ingredients are added, in which the complete dry composition is placed directly into the mouth for absorption without the requirement of added fluids. For placement directly into the mouth, the dry powdered composition must be of sufficiently small mesh size (mean aperture size) to dissolve quickly. However, because sugar and other polysaccharides are increasingly hygroscopic with increasing fineness, a means of producing more saliva is needed. This is accomplished with the addition of a “souring” ingredient, usually an organic acid such as citric or malic acid in sufficient proportion to mitigate the dryness caused by the fine powdered sugars. In order to gauge the amount of comestible consumed, the package containing the comestible possesses a window with graduated indicia so that the level of product is visible.

In one aspect of the invention, a powdered comestible for correcting glucose levels is supplied in a flavored and powdered form that quickly dissolves in the mouth in single or multiple dose packaging. The corrective offers multiple advantages over previous oral means for correcting glucose levels, (1) the product will not cake, (2) is not messy like gel, (3) dissolves readily in the mouth (4) maintains flavor, (5) packs well in a lunchbox, (6) will not damage containers such as purses, by leakage (7) individual dose packaging eliminates confusion, (8) the composition does not have the appearance, texture or flavor of typical edible blood glucose correctives, and (9) the composition requires no refrigeration.

In the case of hypoglycemic condition, the unique attributes of the invention provide an oral means to control hypoglycemia that adults and especially children who tend to be self-conscious, will unhesitatingly use without fearing the stigma that is can be associated with previous products which have a “medicinal” appearance.

Powdered compositions for the correction of mild hypoglycemia are preferably a composition of powdered D-glucose and a glucose equivalent such as spray-dried maltodextrin which possesses amorphous sugar crystals that dissolve quickly in the mouth without requiring water. The powder is flavored with natural favoring which is an essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional. The powder preferably includes ascorbic acid for a vitamin C supplementation and to retard oxidation. Preferably, a binder and colorant such as beet root powder is included. The dry powdered mixture of D-glucose, maltodextrin and flavoring produces a base composition to which particular constituents can be added for different purposes, but sharing the common aspect of being introduced into the mouth directly in powdered form. An anti-caking ingredient such as silicon dioxide or calcium silicate can be added prior to packaging.

In another aspect of the invention, vitamins other than vitamin C (ascorbic acid) are introduced yielding a flavored dry powdered dietary supplement that is introduced directly into the mouth via single or multiple dose packaging.

In yet another aspect of the invention, energy boosting ingredients such as caffeine are provided in a flavored dry powdered energy powder that is introduced directly into the mouth via single or multiple dose packaging.

In still another aspect of the invention, fiber that is water soluble, or a combination of water soluble and non water soluble fiber with flavorings that is introduced directly into the mouth via single or multiple dose packaging.

Regardless of the added flavorings and ingredients, the composition is placed directly in the mouth without the requirement of additional fluids. The composition dissolves readily with no unpleasant aftertaste.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts. Drawing figures within this disclosure may include trademarked or copyrighted material.

FIG. 1 is a side perspective view of a preferred embodiment according to the present invention that shows a can 10 for containing a powdered composition including a translucent window with graduations 12 to indicate the current amount of product;

FIG. 2 is a side perspective view of test tube containers 10 including a graduated window 12;

FIG. 3 is a side perspective view of a bottle-type container 10 with a graduated window 12;

FIG. 4 is a side perspective view of a tubular package 10 with a graduated window 12.

### DESCRIPTION OF THE PREFERRED EMBODIMENTS

In the following description, numerous details are set forth to provide an understanding of the present invention. Those skilled in the relevant art will comprehend that the present invention may be practiced without these details and that numerous variations or modifications from the described embodiments may be possible. Accordingly, the materials, methods, and examples are illustrative only and not intended to be limiting. Unless otherwise explained, any technical terms used herein have the same meaning as commonly understood by one of ordinary skill in the art to which this disclosure belongs. The singular terms “a,” “an,” and “the” include plural referents unless the context clearly indicates otherwise. Similarly, the word “or” is intended to include “and” unless the context clearly indicates otherwise. The term “image” refers to any kind of marking applied at any point in the disclosed production process to the sleeved device whether textual or decorative. The term “comprises” means “includes.” The term “graduated” or “graduations” or “time-graduated” means any visible indicator or indicia applied on the packaging that indicates the level or amount of comestible product remaining in a container before and after ingesting or dispensing a serving. Indicia can correspond to any time increment such as days, hours and minutes. For example, a container can have a viewing window is graduated in 5 one-hour increments. In the case of an energy boosting composition, if a user wishes to ingest enough product to obtain an energy boost for only 2 hours prior to bedtime, the indicator avoids over-consumption which would lead to sleeplessness. Although methods and materials similar or equivalent to those described herein can be used in the practice or testing of this disclosure, suitable methods and materials are described below. Publications, patent applications, patents, and other references mentioned herein, if any, are incorporated by reference in their entirety for all purposes. In case of conflict, the present specification, including explanations of terms, will control.

The following are merely exemplary compositions which can be used according to the present invention, and are not intended to limit the invention:

Base Composition Example

1) Provide a simple sugar powder corresponding to preferably a screen mesh size from #80 to #325, and most preferably at least #100 mesh,

2) provide a gluten-free spray derived maltodextrin powder with a dextrose equivalent (DE) between 5 and 20 corresponding to preferably a screen mesh size from #80 to #325, a most preferably at least #100 mesh,

3) mix ratio of D-glucose to Maltodextrin at least preferably 1:1, and still more preferably a range between (1:1-1:4),

4) add an acidic (sour to taste) component such as citric, malic, ascorbic acid, or any combination thereof; and,

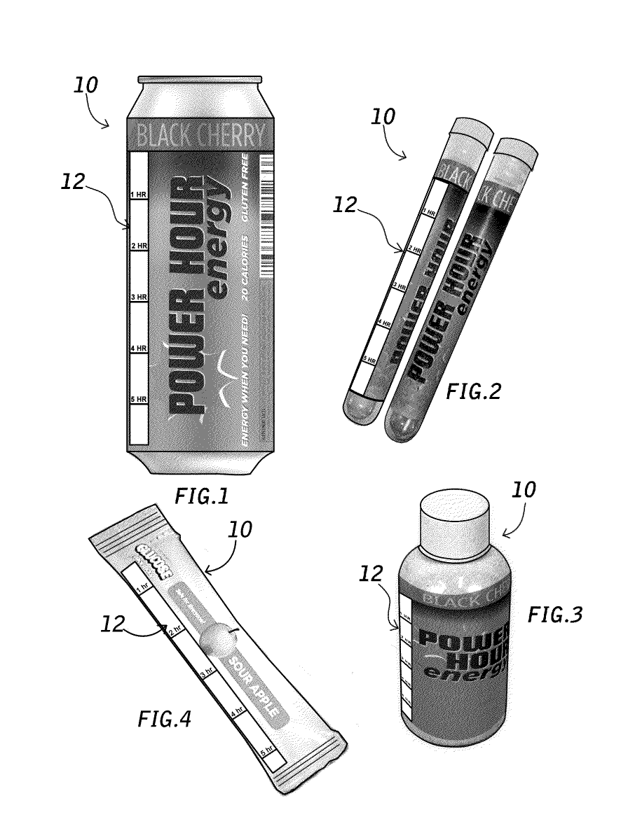

5) package base composition into a container as shown in FIGS. 1-3, or a flexible tubular package (not shown) with graduated windows.

Hypoglycemic Corrective Example

1) Beginning with base composition, and using dextrose as the simple sugar constituent, add ascorbic acid, beet root powder and natural flavorings and mix in a drying (dehydrating) powder blender for at least 20 minutes, and,

2) package in single dose package including at least 9 grams of total carbohydrates to include at least 7 grams of sugar obtained from the D-glucose/Maltodextrin composition, or package in a single dose package including at least 4 grams of total carbohydrates to include at least 4 grams of sugar in the form of the D-glucose/Maltodextrin composition.

Energy Booster Example

1) Beginning with base composition, add flavoring and energy boosting ingredients which are capable of passing through at least a #80 mesh screen, such as at least one of the following: ginseng, gotu kola, ginger, tumeric, maitake, MSM, DMAE, NADH, licorice root, black walnut, fennel, peppermint, and cayenne, rhodiola, DHA, EPA, ascorbic acid, B-vitamins, or CO-Q10,

2) mix in a drying (dehydrating) powder blender for at least 20 minutes; and,

3) in in dry powdered form, package single dose package or multiple-dose packaging as depicted in FIGS. 1-3 having a window that shows the current product level.

Vitamin Supplement Example

1) Beginning with base composition, add flavorings and ingredients which are capable of passing through at least an #80 mesh screen, such as at least one of the following: ginseng, gotu kola, ginger, tumeric, maitake, MSM, DMAE, NADH, licorice root, black walnut, fennel, peppermint, and cayenne, rhodiola, DHA, EPA, ascorbic acid, CO-Q10, B-vitamins, vitamin A, vitamin D, vitamin E, folic acid, biotin, panothenic acid, iodine, iron, magnesium, zinc, inositol, calcium, selenim, copper, manganese, chromium, molybdenum, potassium, boron, betaine HCl;

2) mix in a drying (dehydrating) powder blender for at least 20 minutes; and,

3) in in dry powdered form, package single dose package or multiple-dose packaging as depicted in FIGS. 1-3.

Dietary Fiber Supplement Example

1) Beginning with base composition, add flavorings and ingredients which are capable of passing through at least an #80 mesh screen which are taken from at least one of the following: soluble fiber, insoluble fiber;

2) mix in a drying (dehydrating) powder blender for at least 20 minutes; and,

3) in in dry powdered form, package single dose package or multiple-dose packaging as depicted in FIGS. 1-3.

Hypoglycemic Corrective Use Example

1) hypoglycemic condition is self detected by subject or detected by another,

2) hypoglycemic subject or another obtains dry powdered composition of the invention which includes:
(i) at least 4 grams of soluble carbohydrates in a dry powdered form,
(ii) powdered D-glucose,
(iii) at least one additional powdered dextrose equivalent,
(iv) flavoring, and,

3) packaging containing the composition is opened, and the contents are poured directly into the mouth of the hypoglycemic subject by self administration, or administration by another, and,

4) subsidence of hypoglycemic manifestations is monitored by subject or another, with additional action taken if required.

Because caffeine, as well as some other stimulants are metabolized by the body at a certain rate, the consumer using the methods disclosed herein, can gauge how much product to ingest for a given duration of time which is especially useful in avoiding ingesting more product than is required. The graduated window also indicates to the consumer how much product they have previously ingested, lest they forget. While the gauging means is disclosed as part of a container containing dry powdered comestibles, conceivably, the disclosed packaging with gauging means having markings that indicate increments of time or time durations, can be used with liquid compositions alone, or in combination with dry powdered compositions.

The graduated window is preferably formed from the packaging itself, generally by providing a clear window that can be produced by using clear packaging material having a printed ink overlay for the colored remainder of the package. If blow molding the container, a clear polymer resin can be placed in the mold prior to molding the remainder of the container to form the “window.” Methods for mixing clear and colored resins to produce unitary plastic containers with various colored regions are well established in the art, and are therefore omitted from this disclosure.

While the invention has been described by the embodiments given, it is not intended to limit the scope of the invention to the particular form set forth, but on the contrary, it is intended to cover such alternatives, modifications, and equivalents as may be included within the spirit and scope of the invention as disclosed.

1. A method of packaging and dispensing a quantity of dry-powdered comestible to mitigate a condition of human fatigue among others, comprising the steps of:
1) providing a container holding multiple servings of the comestible,
2) providing a dry powdered comestible product including at least one finely ground sugar with at least one flavoring agent,
3) providing a gauging means on the container for serving a measured amount of comestible including a viewing window having indicia that corresponds to increments of time, whereby a quantity of dry-powdered comestible can be dispensed which corresponds to a typical length of time the comestible is active in a human body once it is ingested.

2. The method according to claim 1 in which the comestible further comprises a powdered organic acid.

3. The comestible according to claim 1, further comprising a powdered polysaccharide.

4. The comestible according to claim 1, further comprising a quantity of powdered caffeine.

5. A method for dietary management to mitigate a condition of human fatigue among others, comprising the steps of:
1) providing a dry powdered comestible product including at least one finely ground sugar, and at least one flavoring agent,
2) packaging the comestible in a container having a window for viewing into the container, in which the window has indicia thereon corresponding to one or more increments of time.

6. The method according to claim 5, in which the simple sugar has a mean aperture of #80 to #325 mesh equivalent.

7. The method according to claim 5, further comprising a quantity of powdered caffeine.

8. A method of packaging and dispensing a quantity of dry-powdered comestible according to a duration of time the comestible is active in the body once ingested, in order to mitigate a condition of human fatigue among others, comprising the steps of:
1) providing a container holding multiple servings of the comestible,
2) providing a dry powdered comestible product including at least one finely ground sugar with at least one flavoring agent,
3) providing a gauging means on the container including a viewing window having indicia that corresponds to increments of time for serving a measured quantity of comestible corresponding to activity time.
